(19) United States
(12) Patent Application Publication
(10) Pub. No.: US 2005/0007455 A1
(43) Pub. Date: Jan. 13, 2005

(54) Information processing apparatus, information processing method and software product

(75) Inventors: Masahiro Yamazaki, Yokohama (JP); Hideki Kuwamoto, Fujisawa (JP)

Correspondence Address: McDermott, Will & Emery, 600, 13th Street, N.W., Washington, DC, 20005-3096, US

(73) Assignee: HITACHI, LTD.

(21) Appl. No.: 10/885,701

(22) Filed: Jul. 8, 2004

(30) Foreign Application Priority Data
Jul. 9, 2003 (JP) 2003-194008

(51) Int. Cl. H04N 5/225

(52) U.S. Cl. 348/207.99

(57) ABSTRACT

An information processing apparatus that comprises a camera that outputs picture information, a selector which selects one mode of the camera from a plurality of modes including an ordinary image-taking mode to take a picture as an ordinary camera function and a recognition mode to recognize a character included in a picture information output by the camera, and a speaker that outputs a notification sound. The information processing apparatus includes a CPU that executes control so that ,when a shutter button is operated by a user to operate the camera, the speaker outputs the notification sound at a first output level if the ordinary image-taking mode is selected, and the speaker does not output the notification sound or outputs the notification sound at a second output level lower than the first output level if the recognition mode is selected.

### TECHNICAL FIELD

The present invention relates to an information processing apparatus such as a cellular phone, a PHS (Personal Handy-phone System), a PDA (Personal Digital Assistant) or a laptop or handheld Personal Computer as well as to an information-processing method adopted by the apparatus and software used in the apparatus.

### BACKGROUND

Japanese Patent Laid-open No. 2002-252691 discloses a portable phone terminal capable of inputting printed information such as an address, a phone number and a URL (Uniform Resource Locator) by using an OCR (Optical Character Recognition) function.

The above document does not describe a way to handle a shutter sound.

A cellular phone having a camera has been released in Japan. The cellular phone outputs a shutter sound to prohibit a misuse of the camera when a user takes a picture. The camera can not be operated without providing a sound that informs others of the operation, thus, the user can not secretly take pictures of others. However if a shutter sound is output every time an OCR function is used, the sound may bother a user.

There is a need for an improved information processing apparatus.

### SUMMARY

The above stated need is met by an information processing apparatus that comprises a camera that outputs picture information, a selector which selects one mode of the camera from a plurality of modes including an ordinary image-taking mode to take a picture as an ordinary camera function and a recognition mode to recognize a character included in a picture information output by the camera, and a speaker that outputs a notification sound. The information processing apparatus includes a CPU that executes control so that ,when a shutter button is operated by a user to operate the camera, the speaker outputs the notification sound at a first output level if the ordinary image-taking mode is selected, and the speaker does not output the notification sound or outputs the notification sound at a second output level lower than the first output level if the recognition mode is selected.

### BRIEF DESCRIPTION OF THE DRAWINGS

FIG. 1 is a block diagram showing a configuration of an information processing apparatus.

FIG. 2 shows a flowchart representing a processing procedure of an information processing apparatus.

FIG. 3 is a diagram showing exemplary display screens of an information processing apparatus.

FIG. 4 shows a flowchart representing a processing procedure of an information processing apparatus.

FIG. 5 is a diagram showing exemplary display screens of an information processing apparatus.

FIG. 6 is a diagram showing an exemplary display screen of an information processing apparatus

FIG. 7 is a table showing a relation between recognized characters and a displayed picture.

FIG. 8 is a diagram showing an exemplary screen displaying a result of recognition in an information processing apparatus.

FIG. 9 is a diagram showing exemplary screens displaying a result of character recognition in an information processing apparatus.

FIG. 10 is a diagram showing exemplary display screens of an information processing apparatus

FIG. 11 is a diagram showing a rough view of an information processing apparatus.

### DETAILED DESCRIPTION

Preferred examples of an information processing apparatus such as a cellular phone, a PHS, a PDA and a laptop or handheld Personal Computer will be described by referring to the drawings. Identical configuration elements are denoted by the same reference numeral through out the figures.

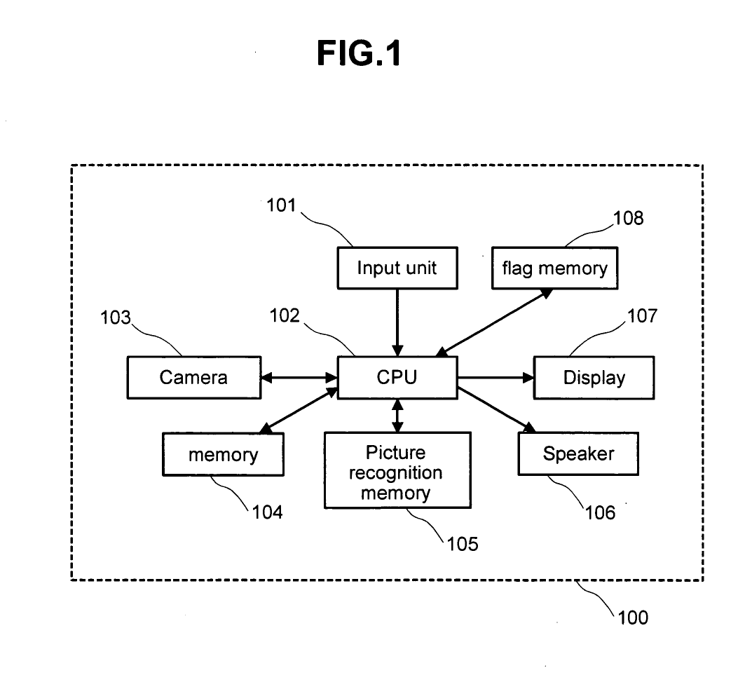

FIG. 1 is a block diagram showing a configuration of an information processing apparatus 100.

An input unit 101 includes a shutter button, a power-supply button and a plurality of keys including numeric keys. The user operates the input unit 101 to enter information such as an image-taking command requesting a camera 103 to take a picture, a power-supply ON/OFF command, a phone number and an email address. A CPU (Central Processing Unit) 102 controls components of the information processing apparatus 100 by execution of a program stored in a memory 104.

The camera 103 converts an object of photographing into picture information of a YUV system and supplies the picture information to the CPU 102. Examples of the photographed object include the face of a person, a piece of scenery and characters. The picture of the YUV system is 3 pieces of information, which are represented by a luminance signal (Y), a difference (U) between the luminance signal and a red-color component and a difference (V) between the luminance signal and a blue-color component.

The picture information converted by the camera 103 is not limited to the YUV system. An object of photographing may be converted into any form of picture information as long as the picture information can be handled by the CPU 102.

The CPU 102 converts the picture information of the YUV system into picture information of an RGB (Red Green Blue) system or the like, and outputs the converted picture information to a display 107.

While looking at the picture information output to the display 107, the user selects a picture to be taken and presses the shutter button. When the user presses the shutter button, a memory 104 stores picture information output by the camera 103.

The memory 104 is typically a ROM (Read Only memory) or a RAM (Random Access Memory). The memory 104 is also used for storing video and/or audio data and software to be executed by the CPU 102 in order to carry out operations or the like.

A picture recognition memory 105 stores a software program to be executed for an OCR (Optical Character Recognition) function by the CPU 102. The OCR function is a function to recognize character including a letter, a sign, a symbol, a mark, a number, and identification information or the like included in a picture.

Examples of the identification information are a home page address, a email address, a post address, a phone number, geographical information or the like. The scope of the identification information is not limited to these examples. The identification information may be any information as long as the information can be used for identifying a thing.

The recognition of character comprises the steps of identifying a place includes characters from a picture taken by the camera 103, , dividing the image date for the portion containing characters into predetermined portions, converting each of the data for the portions into a parameter value and determining what information is included in each of the portions on the basis of the parameter value.

As an example, recognition of characters ‘abc’ included in a picture is explained. First of all, the place at which the characters ‘abc’ is included in the picture is identified. Then, the image data for the portion containing characters ‘abc’ are split into portions containing characters ‘a’, ‘b’ and ‘c’. The data for portions contains characters ‘a’, ‘b’ and ‘c’ are converted into respective parameter values. Examples of the parameter-value digit are ‘0’ representing a white-color portion of a character and ‘1’ representing a black-color portion of a character. For each portion, a character most resembling the parameter value is selected among characters included in character pattern data. The character pattern data is data associating each parameter value with a character such as an alphabetical character corresponding to the parameter value. The character pattern data may be stored in the memory 104 in advance or downloaded or installed by the user.

In this example, a memory dedicated for a picture-processing software is provided as the picture recognition memory 105. As an alternative, picture-processing software may be embedded in the CPU 102 or the memory 104 to provide the CPU 102 with an OCR function. By embedding the picture-processing software in the CPU 102 or the memory 104, the number of components may be reduced and the manufacturing cost and the like may also be decreased as well.

In this example, in order to shrink the circuit scale, the CPU 102 executes the OCR function. However, the configuration of the present invention is not limited to this example. For example, a dedicated processor can be used for implementing the OCR function.

A speaker 106 outputs sounds such as a shutter sound and a call-incoming sound. Speakers can be provided separately for outputting a call sound and outputting reproduced sounds such as an MP3 file and an incoming-call melody. As another alternative, speakers can be provided not only for monaural reproduction but also for stereo reproduction.

The display 107 displays a picture taken by the camera 103 and identification information recognized by the CPU 102. The display 107 also displays screens required for using functions of the information processing apparatus. The screens include information such as power-supply status, the strength of an electric wave, the amount of residual electric charge in a battery, the state of server connection, presence of unread mails, an entered phone number, a destination of a mail, a text of a transmitted mail, a phone number of an incoming call received from a caller, a text of a received mail and data received from a connected Internet screen.

The following description explains a case in which there are two kinds of image-taking mode, i.e., a recognition mode of taking a picture to be recognized and an ordinary image-taking mode of taking a picture of a human being and scenery or the like to be stored as an ordinary camera function. However, the scope of the present invention is not limited to these modes. A flag memory 108 is a memory for storing a mode determination flag used by the CPU 102 to determine the kind of mode. The mode determination flag is handled as a variable in a program of the software stored in the memory 104. The value of the mode determination flag for the recognition mode is different from the value for the ordinary image-taking mode. The CPU 102 determines whether the image-taking mode is the recognition mode or the ordinary image-taking mode on the basis of this variable. In this example, a dedicated memory is provided. However, the mode determination flag can also be stored in the memory 104.

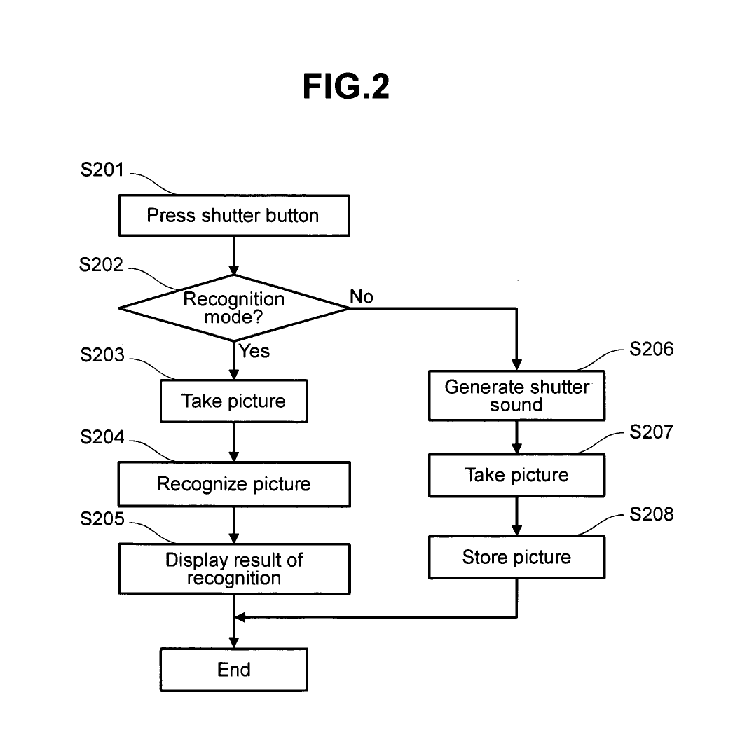

By referring to a flowchart shown in FIG. 2, the following description explains a processing procedure according to the kind of image-taking mode.

A user of the information processing apparatus presses the shutter button of the input unit 101(step S201). Then, the CPU 102 reads out the value of the mode determination flag from the flag memory 108 and determines whether the image-taking mode is the recognition mode or the ordinary image-taking mode (step S202).

If the image-taking mode is the recognition mode, the CPU 102 issues a command for taking a picture to the camera 103 (step S203). In this case, the CPU 102 executes control to prevent a shutter sound from being output. A picture taken and converted by the camera 103 is then stored in the memory 104.

The CPU 102 extracts characters the picture (step S204). An example of characters is a mail address such as ‘yamazaki@..yokohama.ne.jp’, which is typically printed on a business card or the like. The characters are saved in the memory 104 as a result of recognition. The result of recognition is displayed on the display 107 (step S205).

For example, the user takes a mark such as ‘+’,‘?’, ‘?’ or the like appearing at the center of the display 107 to a position above characters such as a name, a mail address, or the like. In this case, the display 107 is used as a viewfinder. Alternatively, the user operates the input unit 101 to move a cursor on the display to specify an area to be recognized.

When the user presses the shutter button after the user indicates the area by the mark or the cursor, the camera 103 outputs picture information to the CPU 102, and the CPU 102 executes recognition of characters . When the characters includes the ‘@’ mark, the CPU 102 recognizes characters before and after the ‘@’ mark as a mail address.

If the identification recognition processing is carried out during reproduction of a moving picture, the reproduction mode is switched to a frame-feeding mode. An object of identification recognition is selected from still pictures displayed in the frame-feeding mode.

It is also possible to provide a configuration with which the user does not need to press the shutter button. Instead, information indicated by the user by using the mark or the cursor is recognized automatically.

In addition, it is also possible to provide a configuration in which, when the user press the shutter button first, identification of a recognition range is performed. The recognition processing is carried out after the user presses the shutter button again or presses another key. The user may mistakenly take the mark or the cursor to a position other than the position of the desired object of recognition. By confirming an object of recognition, it is possible to prevent a wasteful recognition process from being carried out.

If the image-taking mode is the ordinary image-taking mode at the step S202, the speaker 106 outputs a shutter sound in accordance with a command issued by the CPU 102 (step S206). The camera 103 takes the image of an object of photographing (step S207). A picture output by the camera 103 is stored in the memory 104 (step S208).

For example, in the recognition mode, the information processing apparatus can be utilized as an electronic dictionary. In this case, if a shutter sound is output every time the user tries to look up a word into the dictionary, the sound bothers the user. In addition, a shutter sound generated at a quiet place like a library gives unpleasant feelings to surrounding people. Furthermore, one expects that a shutter sound, which is generated in spite of the fact that characters are merely recognized, will make the surrounding people mistakenly think that a picture is being taken.

By outputting a shutter sound in the ordinary image-taking mode and preventing a shutter sound from being output in the recognition mode as described above, it is possible to prevent the user and the surrounding people from having unpleasant feelings.

According to the recognition mode of this example, the user indicates a recognition area on the display 107 as a viewfinder before taking a picture, it is possible to prevent the user taking a picture secretly without a shutter sound. It is preferable that the user can switch to another operating procedure in which the user selects a recognition area after taking a picture. It may be difficult for the user to indicate the recognition area by the mark or the cursor with aiming the camera 103 at a paper or the like. By allowing the user to indicate the recognition area after taking a picture, the user may indicate the area easily. In this case, the picture is stored in the memory 104 temporary and deleted after a predetermined time such as three minutes or five minutes. Outputting the picture from the information processing apparatus 100 is prohibited even before the predetermined time period. By prohibiting the output of the picture, the misuse of the user may be prevented.

In the example described above, control is executed to prevent a shutter sound from being generated. It is to be noted, however, that control can also be executed to lower the output level (reduce the volume) of the shutter sound. In this case, when the CPU 102 determines that the image-taking mode is the recognition mode, the CPU 102 lowers the output level of the shutter sound to a level below the output level for the ordinary image-taking mode. For example, the CPU 102 executes control to generate a shutter sound at a lowest output level. In this case, by enclosing the characters serving as an object of recognition in a closed line and displaying the enclosed characters, the user is capable of easily knowing which characters have been recognized from the display.

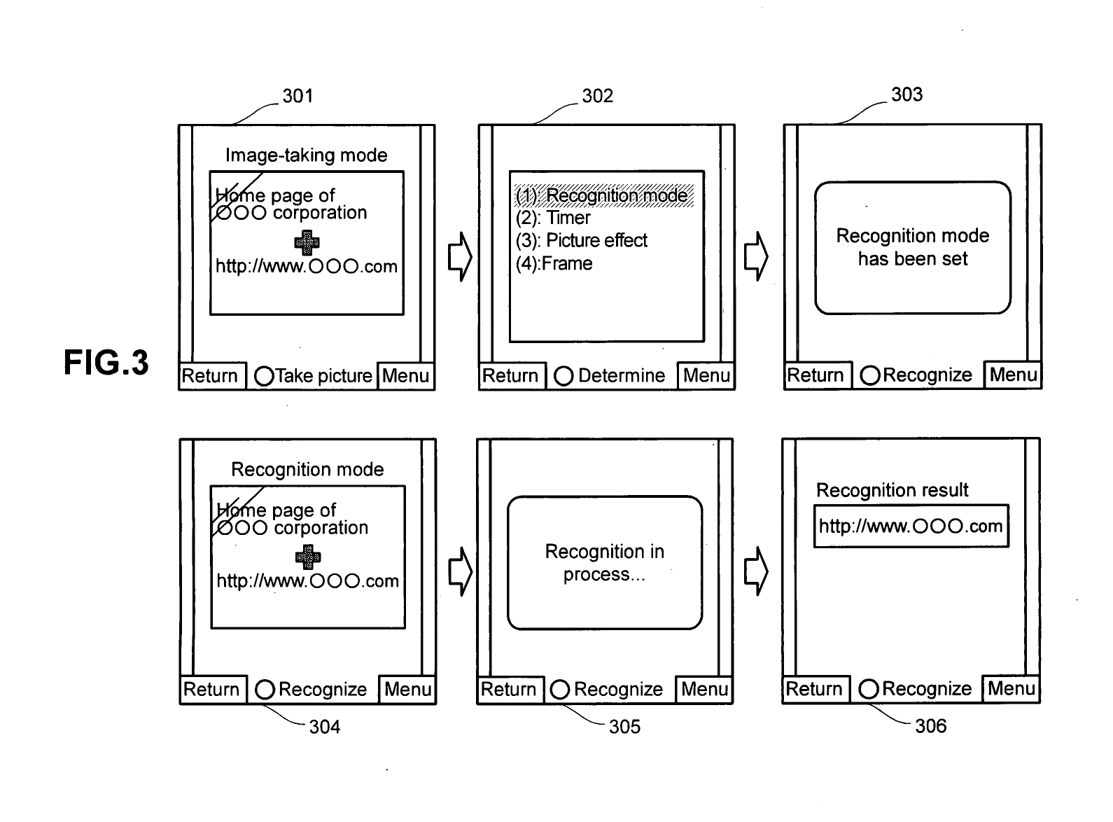

FIG. 3 is a diagram showing exemplary display screens of an information processing apparatus. Screens 301 to 303 display an operation procedure to change the image-taking mode from the ordinary image-taking mode to the recognition mode. Screens 304 to 306 display an operation procedure to output a result of character recognition for a URL or a mail address in the recognition mode to the display 107.

The user manipulates the input unit 101 to output a certain menu screen on the display 107. For example the user presses a switch provided on the rear face of the information processing apparatus. By selecting a menu item such as ‘Camera Start’, the screen 301 is displayed. If a ‘Menu’ button on the right lower corner of the screen 301 is pressed, the screen 302 is displayed. The screen 302 shows a menu related to an image-taking operation. If ‘(1) Recognition mode’ is selected, the screen 303 is displayed.

The screen 303 is a screen for informing the user that the recognition mode has been set as the image-taking mode. When a ‘Recognize’ button is pressed, the screen 304 is displayed. The screen 304 shows a state in which the recognition mode has been started. When a ‘Recognize’ button is pressed, the screen 305 is displayed without generating a shutter sound. The screen 305 is a screen for informing the user that a recognition process is being carried out. As the recognition process is finished, the screen 306 is displayed. The screen 306 is a screen showing a result of the recognition process.

By outputting the display screens described above to the display 107, the user is capable of selecting the recognition mode with ease and, hence, recognizing an identification serving as a recognition object such as a mail address and a URL.

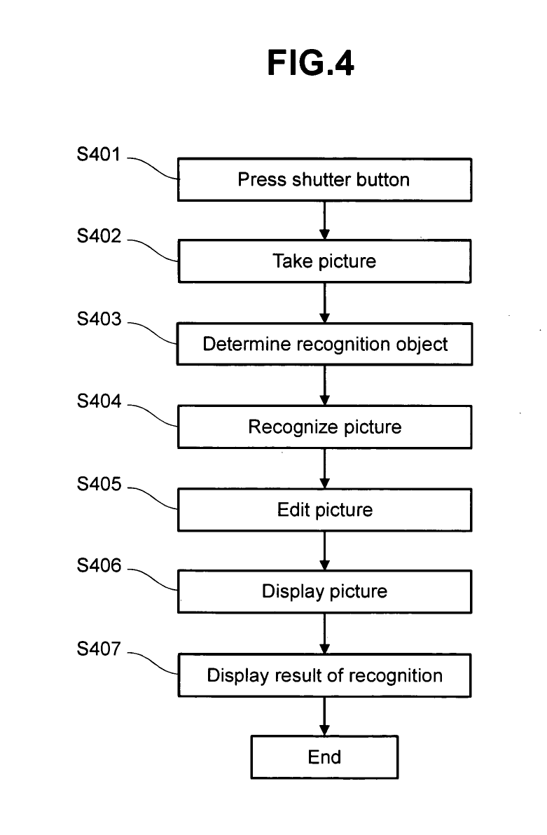

FIG. 4 shows a flowchart representing a processing procedure carried out to edit a taken picture and display a picture obtained as a result of the editing process when the recognition mode is set as the image-taking mode.

The information processing apparatus stores software for executing this picture-editing procedure in the memory 104. The CPU 102 executes the procedure based on the software. In this example, in order to shrink the circuit scale, the picture-editing function is embedded in the CPU 102. However, the configuration of the present invention is not limited to this example. For example, a dedicated chip can be used for implementing the picture-editing function.

The CPU 102 gives a command to take a picture to the camera 103 when the shutter button is pressed (step S401). The camera 103 converts an object of photographing into picture information and stores the picture information in the memory 104 (step S402).

The CPU 102 executes the program of the picture recognition memory 105 and determines an object range including characters as an object of recognition from the picture information saved in the memory 104 (step S403). For example, assume that a rectangular range is determined as the object range. The rectangular range has a diagonal connecting a point separated away from the origin at the left upper corner of the picture in the right direction by X0 pixels and in the downward direction by Y0 pixels to another point separated away from the origin in the right direction by X1 pixels and in the downward direction by Y1 pixels. In this example, the picture recognition operation automatically determines an object range. However, the user can arbitrarily set an object range typically by using a cursor.

The CPU 102 recognizes characters in the object range of the picture and stores a result of the recognition in the memory 104 (step S404). The CPU 102 edits portions other than the recognition range, producing a new picture different from the original picture, and stores the new picture in the memory 104.

Then, the CPU 102 reads out the new picture and the picture of an object of recognition from the memory 104, displaying those pictures on the display 107 (step S406). Finally, at the next step S407, the CPU 102 reads out the result of the character recognition process from the memory 104 and outputs the result to the display 107.

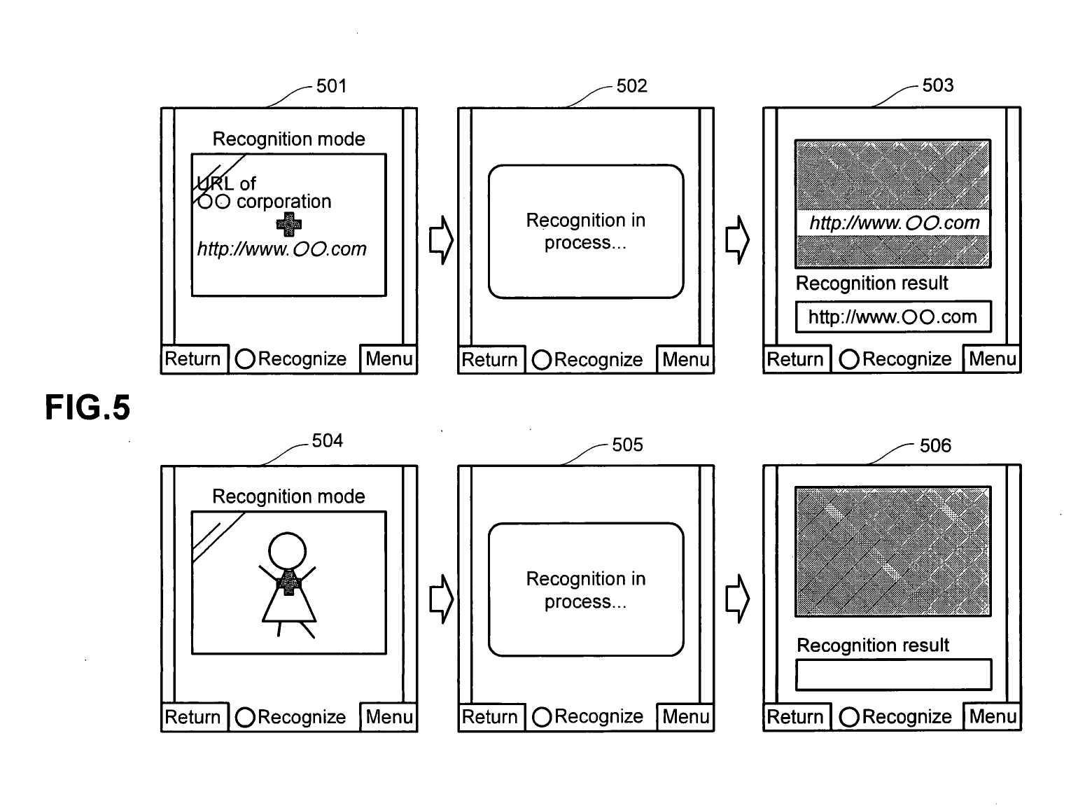

FIG. 5 is a diagram showing exemplary display screens of an information processing apparatus. The description explains a case in which characters such as a URL printed on a piece of paper like a business card are read out from the paper.

A screen 501 is a screen showing a state in which the recognition mode has been started. When a ‘Recognize’ button on the screen 501 is pushed, a screen 502 is displayed. The screen 502 shows that a recognition process is being carried out. As the recognition process is finished, a screen 503 is displayed. The screen 503 is a screen for editing a picture of a portion other than the recognition object such as characters and displaying a result of recognition along with a picture obtained as a result of editing.

The following description explains a case of taking a picture of a person in the recognition mode. When a ‘Recognize’ button is operated with displaying a person on the display 107 as shown in a screen 504, a screen 505 is displayed. The screen 505 shows that a recognition process is being carried out. If identification information such as characters does not exist as is the case with a taken picture of a person, the entire screen of the taken picture is painted out with a black color to display a screen like a screen 506.

It is to be noted that, if the recognition process can be carried out in a short time, the CPU102 can be executed to output a shutter sound from the speaker 106 instead of displaying a picture different from the taken picture.

The recognition mode may be used for a stealing picture-taking operation or the like, because a picture can be taken without a shutter sound or with a little shutter sound. Even if an attempt at a stealing photographing operation is carried out, a picture other than characters and symbols is not displayed, or a shutter sound is output. Thus, a stealing photographing operation can be prevented.

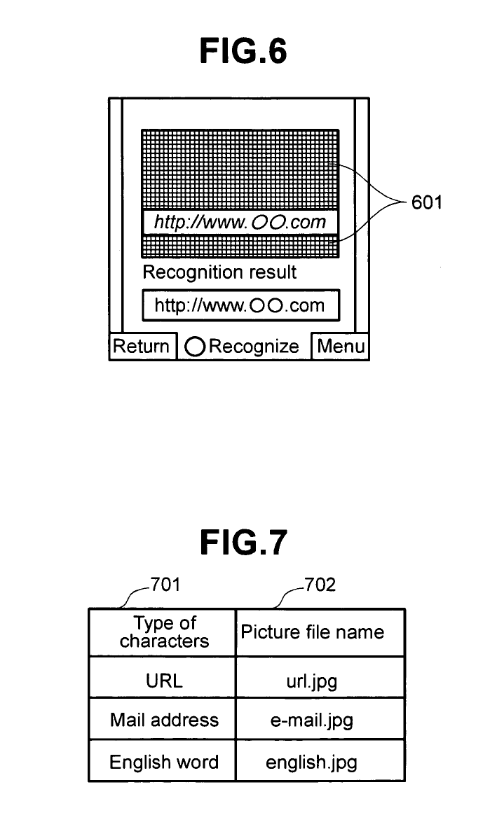

It is to be noted that the color of the portion other than the object of recognition is not limited to the black. That is to say, such a portion can be painted out with another color such as the red or the yellow. As an alternative, such a portion can be expressed by a pattern such as a lattice pattern as shown in FIG. 6, a striped pattern or a polka-dot pattern. In addition, if characters which serve as an object of recognition can be detected by the sense of sight, the portion can be displayed by mosaic. As another alternative, a pattern or a portion of another picture can be displayed.

In addition, in order to make the result of recognition easy to understand, the display may be inverted by changing the black color to the white and the white color to the black or the colors of the display may be changed. However, the present invention is not limited to the typical displays described above. The result of recognition can be shown in any display as long as the result of recognition can be identified clearly in the picture. For example, instead of displaying a result of recognition in terms of characters, the result of recognition can be displayed as decorated characters, a still picture or a moving picture to represent the result.

FIG. 7 is a table showing a relation between recognized characters and a displayed picture. The table associates the type of identification information 701 recognized by the CPU 102 with a picture file name 702, which is the name of a file containing a displayed picture. This table is stored in the memory 104. For example, the CPU 102 recognizes the type of identification information based on the result of the existence of the characters “http:” or the character “@” in the identification information.

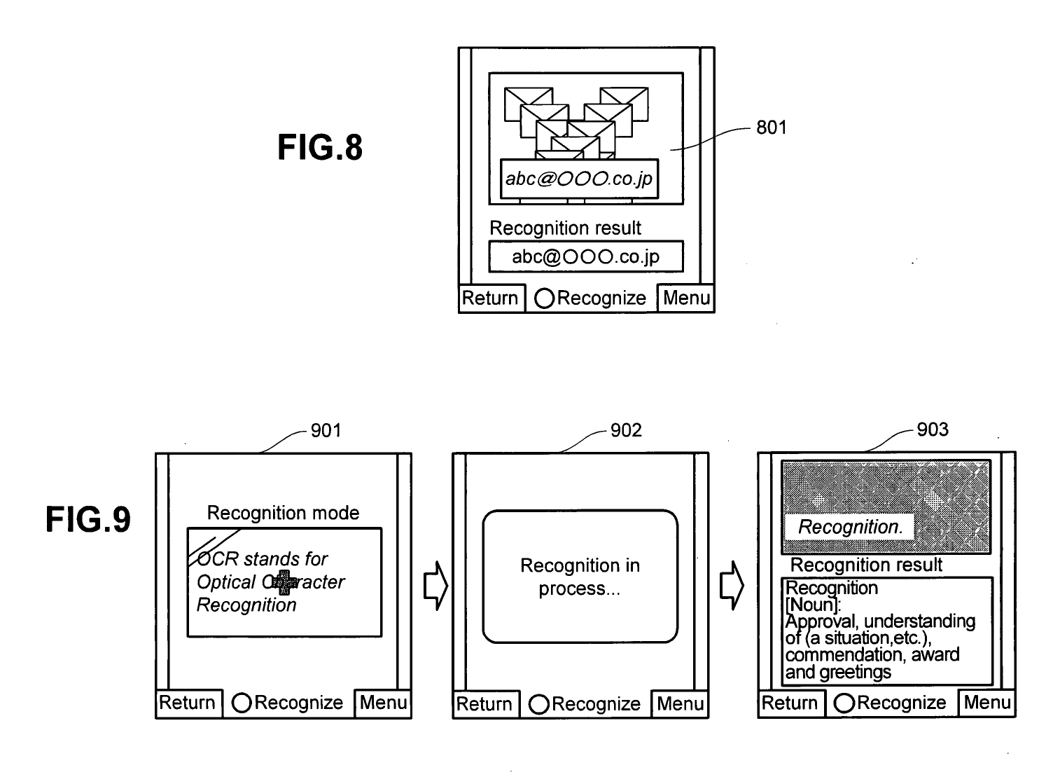

FIG. 8 is a diagram showing a screen displaying a result of character recognition. In the screen, characters serving as an object of recognition are determined to be a mail address. A picture file e-mail.jpg for an email address is read out from the memory 104.

By displaying a picture related to the object of recognition in this way, the user is capable of intuitively knowing a result of recognition of desired characters. In addition, if there is provided a table for cataloging a relation associating each mail address with the picture of a person to which the email address is assigned, the user is capable of easily knowing a person to which an email address obtained as a result of recognition is assigned. Thus, the user is capable of utilizing the information-processing apparatus with a higher degree of convenience.

Alternatively, a picture selected at random among taken pictures is displayed on a portion other than characters serving as an object of recognition. After characters have been recognized in the recognition mode, a recognition-end signal indicating the end of a recognition process is supplied to the CPU 102. Receiving the recognition-end signal, the CPU 102 randomly selects a picture stored in the memory 104 and displays the picture on the display 107. Since the displayed picture varies from recognition to recognition, the user is not familiar with a picture, which is displayed every time an identification is recognized. Thus, the user does not get tired of a displayed picture due to the same picture displayed for every recognition. As a result, the user can enjoy the information-processing apparatus more.

It is to be noted that, a picture displayed on a portion other than an object of recognition does not have to be a picture stored in the memory 104 in advance. For example, the picture can also be a picture created by the user by using picture creation software or a picture downloaded from the Internet. Thus, the number of variations of the displayed picture increases, allowing the user to utilize the information-processing apparatus with a higher degree of convenience.

Furthermore, a recognition object such as characters can be displayed in an enlarged or shrunk size. An example of an enlarged display is a display using 2×2 pixels for an original display using 1×1 pixels. By displaying a recognition object in an enlarged or shrunk size, the user can recognize the result of recognition with ease. Moreover, if the recognized character is enlarged, most of the originally taken picture will be hidden so that an effect of avoiding a stealing photographing operation can also be obtained.

The following description explains an example in which information related to a result of recognition is displayed with the result.

The memory 104 stores a dictionary data such as an English-English dictionary. Definitions of a word are read out from the memory 104 when the word is recognized by using a character recognition function. The word and the definition are displayed as the recognition result and the information related to the result respectively. The memory 104 may store a plurality of dictionary dates such as an English-Japanese dictionary and an English-Spanish dictionary or the like other than the English-English one. For example, When the English-Japanese dictionary is selected and an English word is recognized, Japanese translation is displayed as the information related to the recognition result.

In this case, the quantity of the definition of the word may be so large that it cannot be displayed on one or two lines. In order to cope with such a problem, the location for displaying the result of recognition is moved to the top, the bottom, the left side or the right side of the screen of the display 107 in order to provide a larger space for displaying information related to the object of recognition.

FIG. 9 is a diagram showing typical display screens for a process of recognizing characters. A screen 901 displays a state in which a page of a piece of paper is being monitored. The page contains words. If a ‘Recognize’ button is pressed when characters ‘Recognition’ on the display 107 is indicated by the mark or the cursor, the process of recognizing characters is started and a screen 902 is displayed to replace the screen 901. As the process of recognizing characters is finished, a screen 903 is displayed to replace the screen 902. On the screen 903, the display of the entire taken picture is shifted upward to provide a space available for displaying definitions of the word “Recognition”, which serves as an object of recognition. By shifting the display position in this way, it is possible to display information related to the object of recognition so that the user is capable of utilizing the information-processing apparatus with a higher degree of convenience.

It is to be noted that, in this example, the data of the display-position shift is stored in the memory 104 in advance. The data of the display-position shift includes the direction, distance and destination of the shift of the recognized characters. The CPU 102 shifts the characters serving as an object of recognition in accordance with the data of the display-position shift. However, the present invention is not limited to this example. For example, an optimum new location and/or the distance of the shift can also be found from the amount of the taken-picture information and/or the amount of the related information. In this way, the CPU 102 can shift the characters serving as an object of recognition to the new location, which can be seen by the user with ease, in accordance with the display contents.

In this case, it is desirable to provide a configuration in which the characters serving as an object of recognition is shifted by keeping a positional relation between the object of recognition and pictures other than the object unchanged. In this way, the user is capable of easily knowing what characters have been recognized and, hence, utilizing the information-processing apparatus with a higher degree of convenience. If a different characters have been recognized, for example, it will be easy to know the relation between the location of characters wanted to be recognized and the location of the characters recognized mistakenly. Thus, the user is capable of easily moving a recognition range to the desired characters by using the cursor or the like.

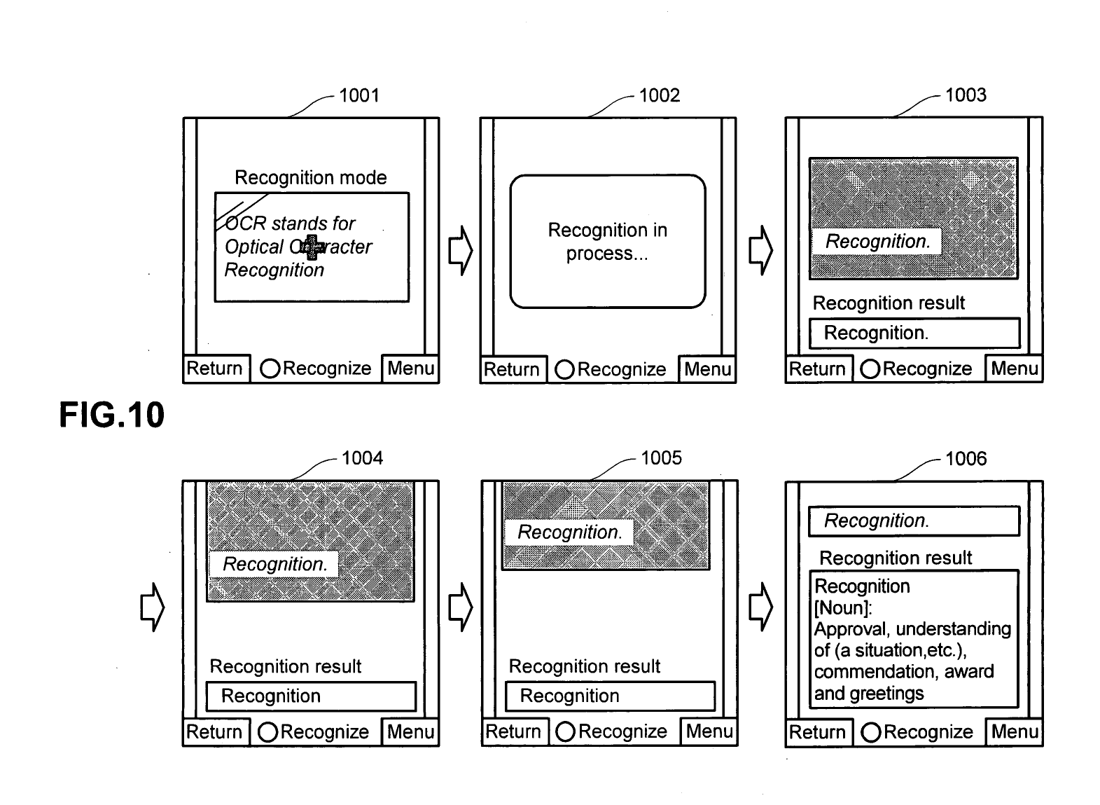

FIG. 10 is a diagram showing exemplary screens displaying results of character recognition. A screen 1001 is a screen showing the page of a monitored piece of paper, on which words are written. When a character recognition process is carried out, a screen 1002 is displayed to replace the screen 1001. As the character recognition process is finished, a screen 1003 is displayed to replace the screen 1002.

On the screen 1003, the string of characters “Recognition” serving as an object of recognition is displayed at the same position as that during the monitoring process. Screens 1004 and 1005 display a state in which the whole picture is being shifted gradually in the upward direction. Then, as shown in a screen 1006, only the picture portion of the string of characters “Recognition” serving as an object of recognition is displayed and an available space is used for displaying related information such as a definition of a word.

By changing the display format gradually in this way, the user is capable of knowing the position of the recognition object, and a lot of information on a result of recognition can be displayed even on a terminal having a small screen. Thus, the user is capable of utilizing the information-processing apparatus with a high degree of convenience.

Furthermore, an audio synthesis unit can also be provided as a means for outputting a sound from the speaker 106 as a substitute for characters. As an alternative, there can also be provided a vibration unit, which vibrates like a Morse signal, or a lamp for generating light. As an alternative, there are provided a Braille creation unit for creating Braille from character information and a Braille display for displaying the Braille by changing a shape. In this configuration, the Braille is used as a substitute for characters.

In addition to a display, it is possible to provide a result notification method comprising one result notification technique or a combination of a plurality of such techniques. In this way, a child merely knowing the language little and a person having a weak sense of sight or hearing are capable of knowing the result of recognition with ease.

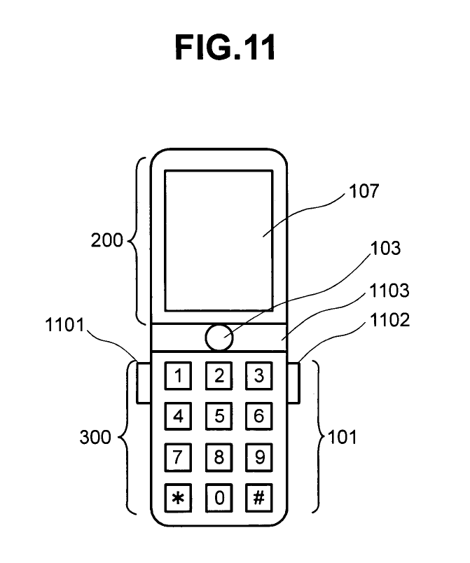

FIG. 11 is a diagram showing an external view of a information processing apparatus. The information processing apparatus comprises a case 200 having the display 107 and a case 201 having the input unit 101. The cases 200 and 201 are joined to each other by a hinge 1103 in such a way that the cases 200 and 201 can be folded over one another. In addition, the information processing apparatus has an ordinary image-taking button 1101 and a recognition image-taking button 1102.

When the ordinary image-taking button 1101 is pressed, the camera 103 takes a picture of a thing serving as an object of photographing and stores the taken picture in the memory 104. If necessary, the taken picture is displayed. If the recognition image-taking button 1102 is pressed, on the other hand, the camera 103 takes a picture of a thing serving as an object of recognition and, after the CPU 102 carries out a recognition process, a result of recognition is displayed on the display 107.

By providing separate buttons dedicated for the recognition button and the ordinary image-taking mode as described above, the user is capable of selecting one of the modes with ease and, hence, utilizing the information processing apparatus with a high degree of convenience. In addition, by providing the buttons on the side faces of the information processing apparatus as shown in FIG. 11, the user is capable of carrying out the same operations without regard to whether the information processing apparatus is opened or folded and, hence, utilizing the information processing apparatus with a higher degree of convenience.

It is desirable to provide the ordinary image-taking button 1101 and the recognition image-taking button 1102 as different buttons. However, the ordinary image-taking button 1101 and the recognition image-taking button 1102 can also be replaced with a single button. By replacing the ordinary image-taking button 1101 and the recognition image-taking button 1102 with a single button, a space can be saved, allowing the size of the information processing apparatus to be reduced. In this case, it is necessary to differentiate a button operation for taking a picture normally from a button operation for recognition. For example, the mode can be switched from the ordinary image-taking mode to the recognition mode and vice versa in accordance with the duration in which the button is being pressed or the number of times the button is pressed, that is, in accordance with whether the button is pressed in a single-click or double-click operation. The ordinary image-taking button 1101 and the recognition image-taking button 1102 can be any ones of sensors pertaining to the information processing apparatus 100 as long as they can be operated by the user.

In addition, in the case of an information-processing apparatus having a call function as is the case with a cellular phone or the like, there is a conceivable case in which a phone call arrives while the OCR function is being executed. In such a case, when informed of the incoming phone call by a communication unit shown in none of the figures, the CPU 102 terminates the recognition mode, stores data such as picture information or a parameter value of character into the memory 104, and processes the call. As the call is finished, the state of the recognition mode is restored.

In this way, it is possible to respond to an incoming phone call even if the phone call arrives while the OCR function is being executed. In addition, the state prior to the arrival of the phone call can be restored quickly after the process to receive and process the phone call is finished. Thus, it is no longer necessary to deliberately resume the recognition mode. As a result, the user is capable of utilizing the information-processing apparatus with a high degree of convenience.

Furthermore, in the case of an information-processing apparatus capable of carrying out an audio communication and a data communication at the same time, the CPU 102 may perform a process to execute both the OCR function and the call function. In this way, the user is capable of recognizing information printed on a business card or the like by using the OCR function while having a telephone-call conversation.

In addition, it is also possible to provide a configuration in which a recognition result given by the OCR function is transmitted to a destination by using a mail function included in the information-processing apparatus such as a cellular phone.

In this case, when the user carries out a predetermined operation on the input unit 101 during a call, the CPU 102 carries out a process to make a transition to the recognition mode. Then, after characters have been recognized, the user operates the input unit 101 to activate the mail function. When the mail function is activated, the CPU 102 executes mail software stored in the memory 104 to display a mail creation screen on the display 107. At that time, if a mail address written on a business card or the like has been recognized, the CPU 101 carries out a process to automatically insert the mail address obtained as a result of recognition into the main-text field of a mail being created.

As an alternative, it is also possible to provide a configuration in which the user is allowed to select an email address from address information stored in the memory 104 in advance and insert the selected email address into the addressee field. The address information includes a name, a phone number and an email address.

As described above, a recognition result produced by the OCR function can be transmitted to a desired communication partner by carrying out a simple operation. Thus, the user is capable of utilizing the information-processing apparatus with a higher degree of convenience. In addition, if a description of the subject can be inserted automatically into the subject field, the operation to enter the description of the subject can be eliminated. Thus, the user is capable of utilizing the information-processing apparatus with an even higher degree of convenience. In this case, the description of the subject may be ‘OCR Results’ or the like.

In addition, in the above description, the main-text field, the addressee field and the subject field are taken into consideration. However, fields of a created mail are not limited to those three fields. That is to say, other fields may be provided. In this case, it is possible to provide a configuration in which information for the newly provided fields can be inserted automatically into the new fields.

Furthermore, in accordance with the above description, there is provided a configuration in which a recognition result such as a mail address is inserted automatically into a field on the mail creation screen. However, the configuration is not limited to this feature. For example, the user is allowed to enter other information such as a comment by operating the input unit 101. That is to say, information transmitted to a phone-call partner includes not only a recognition result produced by the OCR function, but also information such as a comment for the result of recognition. It is to be noted that, in this case, if predetermined phrases, decorated characters or the like, which are stored in the memory 104 in advance, are used, the information-processing apparatus can be utilized with an even higher degree of convenience.

It is also worth noting that the software to be executed for implementing functions of the examples described above does not have to be stored in the memory 104 in advance. Instead, the software can be installed in the information processing apparatus by using the Internet or a recording medium after the user purchases the information processing apparatus. In this case, it is not necessary to newly purchase another information processing apparatus. Since new functions can be added to the purchased information processing apparatus, the cost can be reduced.

The “term recording medium” as used herein refers to any medium that participates in implementing the processing. Such a medium may take many forms, including but not limited to, non-volatile media, volatile media, and transmission media. Non-volatile media include, for example, optical or magnetic disks. Volatile media include dynamic memory. Transmission media may include coaxial cables; copper wire and fiber optics, as well as electric, electromagnetic or light signals that transit such physical links. Transmission media can also take the form of electric or electromagnetic signals, or acoustic or light waves such as those generated during radio frequency and infrared wireless data communications. Common forms of machine-readable media include, for example, a floppy disk, a flexible disk, hard disk, magnetic disk, magnetic tape, any other magnetic medium, a CD-ROM, DVD, any other optical medium, a RAM, a PROM, and EPROM, a FLASH-EPROM, any other memory chip or cartridge, a carrier wave transporting data or instructions.

As described above, it is possible to provide an information-processing apparatus which can be used with a high degree of convenience.

It is to be noted that the scope of the present invention is not limited to the examples described above. Instead, the new characteristics and the principle, which are disclosed in this specification, include a technological range of a broader domain.

1. An information processing apparatus comprising:
a camera that outputs picture information;
a selector which selects one mode of the camera from a plurality of modes including an ordinary image-taking mode to take a picture as an ordinary camera function and a recognition mode to recognize a character included in a picture information output by the camera;
a speaker that outputs a notification sound; and
a CPU that executes control so that:
when a shutter button is operated by a user to operate the camera, the speaker outputs the notification sound at a first output level if the ordinary image-taking mode is selected, and the speaker does not output the notification sound or outputs the notification sound at a second output level lower than the first output level if the recognition mode is selected.

2. The information processing apparatus according to claim 1, further comprising:
a memory which stores at least one picture; and
a display, wherein in the recognition mode, the display displays a character included in a picture information output by the camera in a first display area and the picture stored in the memory in a second display area when the shutter button is operated by the user.

3. The information processing apparatus according to claim 2, wherein in the recognition mode, the memory stores a plurality of pictures associated with a plurality of characters, and the display displays the picture associated with the character included in the picture information output by the camera in a second display area when the shutter button is operated by the user.

4. The information processing apparatus according to claim 1, further comprising:
a memory which stores a plurality of pictures; and
a display which displays a character included in a picture information output by the camera in a first display area and a picture selected at random from the plurality of pictures stored in the memory in a second display area when the shutter button is operated by the user while the recognition mode is selected

5. The information processing apparatus according to claim 1, further comprising:
a display, wherein in the recognition mode, the display displays a character as a viewfinder of the camera before the shutter button is operated by the user and shifts a display position of the character after the shutter button is operated.

6. The information processing apparatus according to claim 1, wherein the character includes at least one of a letter, a sign, a symbol, a mark, a number, and identification information.

7. An information processing apparatus comprising:
a camera that outputs picture information;
a selector which selects one mode of the camera from a plurality of modes including an ordinary image-taking mode to take a picture as an ordinary camera function and a recognition mode to recognize a character included in a picture information output by the camera;
a memory which stores at least one picture; and
a display which displays a character included in a picture information output by the camera in a first display area and the picture stored in the memory in a second display area when a shutter button for the camera is operated by a user if the recognition mode is selected.

8. The information processing apparatus according to claim 7, wherein the memory stores a plurality of pictures associated with a plurality of characters, and the display displays the picture associated with the character included in the picture information output by the camera in a second display area when the shutter button is operated by the user if the recognition mode is selected.

9. The information processing apparatus according to claim 7, wherein the memory stores a plurality of pictures associated with a plurality of characters, and the display displays a picture selected at random from the plurality of pictures stored in the memory in the second display area when the shutter button is operated by the user if the recognition mode is selected.

10. An information processing method comprising the step of:
selecting one mode of a camera of a information processing apparatus from a plurality of modes including an ordinary image-taking mode to take a picture as an ordinary camera function and a recognition mode to recognize a character included in a picture information output by the camera; and
controlling a speaker of the information processing apparatus when a shutter button is operated by a user of the camera so that the speaker outputs the notification sound at a first output level if the ordinary image-taking mode is selected, and the speaker does not output the notification sound or outputs the notification sound at a second output level lower than the first output level if the recognition mode is selected.

11. An information processing method comprising the step of:
storing at least one picture in a memory of a information processing apparatus;
selecting one mode of a camera of the information processing apparatus from a plurality of mode including a recognition mode to recognize a character included in a picture information output by the camera;
recognizing a character included in picture information output by the camera when a shutter button is operated by a user if the recognition mode is selected; and
displaying the recognized character in a first display area and the picture stored in the memory in a second display area.

12. A software product comprising:
a recording medium;
programming code, carried by the recording medium, for execution by a information processing apparatus, wherein execution of the programming code causes the information processing apparatus to implement a series of steps, comprising:
selecting one mode of a camera of the information processing apparatus from a plurality of mode including an ordinary image-taking mode to take a picture as an ordinary camera function and a recognition mode to recognize a character included in a picture information output by the camera; and
controlling a speaker of the information processing apparatus when a shutter button is operated by a user of the camera so that the speaker outputs the notification sound at a first output level if the ordinary image-taking mode is selected, and the speaker does not output the notification sound or outputs the notification sound at a second output level lower than the first output level if the recognition mode is selected.

13. A software product comprising:
a recording medium;
programming code, carried by the recording medium, for execution by a information processing apparatus, wherein execution of the programming code causes the information processing apparatus to implement a series of steps, comprising:
storing at least one picture in a memory of a information processing apparatus;
selecting one mode of the camera of the information processing apparatus from a plurality of mode including a recognition mode to recognize a character included in a picture information output by the camera; and
recognizing a character included in picture information output by the camera when a shutter button is operated by a user if the recognition mode is selected; and
displaying the recognized character in a first display area and the picture stored in the memory in a second display area.

14. A product comprising executable instructions, wherein execution of programming code causes a information processing apparatus to implement a series of steps, comprising:
selecting one mode of a camera of the information processing apparatus from a plurality of mode including an ordinary image-taking mode to take a picture as an ordinary camera function and a recognition mode to recognize a character included in a picture information output by the camera; and
controlling a speaker of the information processing apparatus when a shutter button is operated by a user of the camera so that the speaker outputs the notification sound at a first output level if the ordinary image-taking mode is selected, and the speaker does not output the notification sound or outputs the notification sound at a second output level lower than the first output level if the recognition mode is selected.

15. A product comprising executable instructions, wherein execution of programming code causes a information processing apparatus to implement a series of steps, comprising:
storing at least one picture in a memory of a information processing apparatus;
selecting one mode of the camera of the information processing apparatus from a plurality of mode including a recognition mode to recognize a character included in a picture information output by the camera; and
recognizing a character included in picture information output by the camera when a shutter button is operated by a user if the recognition mode is selected; and
displaying the recognized character in a first display area and the picture stored in the memory in a second display area.
